(19) United States
(12) Patent Application Publication
(10) Pub. No.: US 2018/0317272 A1
(43) Pub. Date: Nov. 1, 2018

(54) COMMUNICATION APPARATUS, CONTROL METHOD, AND RECORDING MEDIUM

(71) Applicant: CANON KABUSHIKI KAISHA, Tokyo (JP)

(72) Inventor: Atsushi Minakawa, Kawasaki-shi (JP)

(21) Appl. No.: 15/957,691

(22) Filed: Apr. 19, 2018

(30) Foreign Application Priority Data
Apr. 28, 2017 (JP) 2017-089722

(51) Int. Cl. H04W 76/15; H04W 76/14; H04W 76/30

(52) U.S. Cl. CPC H04W 76/15; H04W 84/12; H04W 76/30; H04W 76/14

(57) ABSTRACT

A communication apparatus includes a connection unit and a reception unit. The connection unit connects with an other communication apparatus via a first network. The reception unit receives a predetermined signal from the other communication apparatus where the communication apparatus is instructed to acquire a content included in an external apparatus. When the communication apparatus is assigned a role of participating in the first network when the reception unit receives the predetermined signal, the connection with the other communication apparatus is changed to a connection via a second network in which the communication apparatus is assigned a role of establishing a network. When the connection is changed, the content is acquired from the external apparatus via a third network while maintaining the connection via the second network. When the content is acquired, information about reproduction of the content is communicated with the other communication apparatus via the second network.

### BACKGROUND OF THE INVENTION

### Field of the Invention

The present disclosure relates to communication between a plurality of apparatuses.

### Description of the Related Art

There has been a technique for performing wireless mirroring on a screen currently displayed and/or audio currently reproduced by a communication apparatus. Mirroring refers a technique in which a transmission apparatus transmits currently displayed screen information and/or currently reproduced audio information to a reception apparatus via a network to share the currently displayed screen and/or currently reproduced audio between the transmission apparatus and the reception apparatus.

Wi-Fi® Display (Miracast®) is one of such techniques. Wi-Fi® Display defines a source apparatus for transmitting currently displayed screen information and/or currently reproduced audio information, and a sink apparatus for receiving the screen information and/or audio information from the source apparatus.

Japanese Patent Application Laid-Open No. 2016-71638 discusses the above-described mirroring function and a content redirection function performed by a sink apparatus to acquire a content from an external apparatus other than a source apparatus and then display the content. In the content redirection function, the source apparatus transmits information about a content included in the external apparatus to the sink apparatus, and the sink apparatus acquires the content from the external apparatus and then reproduces the content.

When the sink apparatus acquires a content from the external apparatus, as in the content redirection function, the sink apparatus needs to connect to an access point (AP). Therefore, to perform content redirection while maintaining the connection between the sink and source apparatuses, the sink apparatus needs to be capable of concurrently connecting with both the source apparatus and the AP. However, such concurrent connections may not be possible depending on a connection state between the sink and source apparatuses.

### SUMMARY OF THE INVENTION

The present disclosure is directed to suitably acquiring a content from an external apparatus, even if a connection state between a self apparatus and another communication apparatus is not suitable for the content acquisition from the external apparatus.

According to an aspect of the present invention, a communication apparatus includes a first connection unit configured to connect with an other communication apparatus via a first wireless network, a first reception unit configured to receive a predetermined signal from the other communication apparatus via the first wireless network, wherein the predetermined signal is transmitted by the other communication apparatus in a case where the communication apparatus is instructed to acquire a content included in an external apparatus, and wherein the other communication apparatus is connected by the first connection unit, a changing unit configured to change, in a case where the communication apparatus is assigned a role of participating in the first wireless network when the first reception unit receives the predetermined signal, the connection with the other communication apparatus to a connection via a second wireless network in which the communication apparatus is assigned a role of establishing a wireless network, an acquisition unit configured to acquire, in a case where the changing unit has changed the connection with the other communication apparatus, the content from the external apparatus via a third wireless network while maintaining the connection via the second wireless network, and a communication unit configured to communicate, in a case where the content is acquired by the acquisition unit, information about reproduction of the content with the other communication apparatus via the second wireless network.

Further features will become apparent from the following description of embodiments with reference to the attached drawings.

### BRIEF DESCRIPTION OF THE DRAWINGS

FIG. 1 illustrates a network configuration of a communication system.

FIG. 2 illustrates a hardware configuration of a communication apparatus.

FIG. 3 is a diagram including the flowcharts of FIGS. 3A and 3B implemented when the communication apparatus performs content redirection.

FIG. 4 is a sequence diagram implemented by the communication apparatus and another communication apparatus to perform mirroring.

FIG. 5 is a sequence diagram implemented by the communication apparatus, the other communication apparatus, and a cloud server when content redirection is determined be executable based on the role of the other communication apparatus.

FIG. 6 is a sequence diagram implemented by the communication apparatus, the other communication apparatus, and the cloud server when content redirection is determined to be not executable based on the role of the communication apparatus.

FIG. 7 is a diagram including the flowcharts of FIGS. 7A and 7B implemented when the communication apparatus performs content redirection.

### DESCRIPTION OF THE EMBODIMENTS

Embodiments will be described in detail below with reference to the accompanying drawings. Configurations described in the following embodiments are to be considered as illustrative, and the present disclosure is not limited to illustrated configurations.

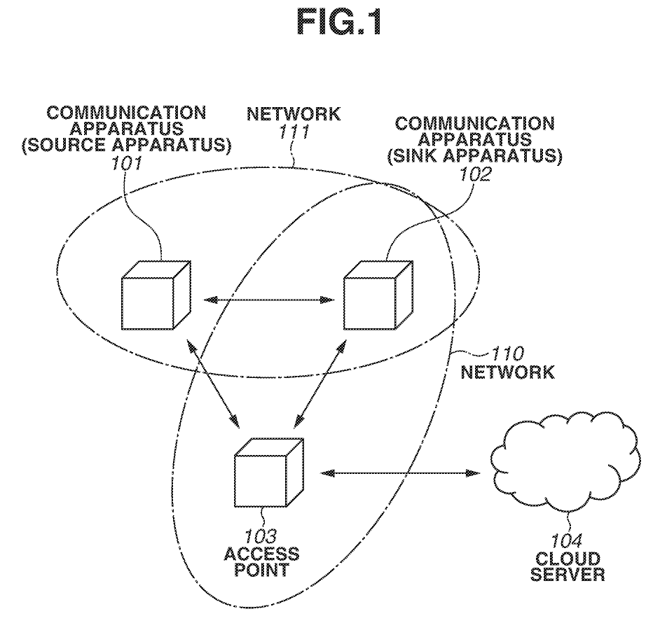

FIG. 1 illustrates a network configuration of a communication system according to the present embodiment. In networks 110 and 111, apparatuses communicate with each other based on a wireless communication method conforming to the Institute of Electrical and Electronics Engineers, Inc. (IEEE) 802.11 series standard.

The network 110 is an infrastructure mode wireless network formed by an access point 103 conforming to the IEEE 802.11 series. A communication apparatus 102 is able to participate in the network 110. A communication apparatus 101 may also be able to participate in the network 110. The access point 103 is provided with a router function. The communication apparatuses 101 and 102 are able to communicate with a cloud server 104 via the access point 103.

The network 111 is a wireless network formed in conformance with Wi-Fi® Peer-to-Peer (P2P) specifications (Wi-Fi Direct® standard). According to the present embodiment, the communication apparatuses 101 and 102 directly communicate with each other via the network 111 in conformance with Wi-Fi® Display specifications (Wi-Fi® Miracast® standard). However, the communication form is not limited thereto. The communication apparatuses 101 and 102 can communicate with each other via the infrastructure mode wireless network defined by the IEEE 802.11 series.

In addition to or instead of wireless communication conforming to the IEEE 802.11 series standard, each apparatus can utilize communication methods conforming to other wireless communication methods, such as Bluetooth®, short-distance wireless communication, Ultra Wide Band (UWB), ZioBee, and Multi Band Orthogonal Frequency Division Multiplexing (OFDM) Alliance (MBOA). Short-distance wireless communications include Near Field Communication (hereinafter referred to as NFC). UWB includes wireless universal serial bus (USB), wireless 1394, and WiNET. Communication methods conforming to a wired communication method such as a wired local area network (LAN) is also applicable.

The communication apparatuses 101 and 102 perform mirroring conforming to Wi-Fi® Display specifications, where the communication apparatus 101 serves as a source apparatus and the communication apparatus 102 serves as a sink apparatus. In this case, each of the source and sink apparatuses performs data transmission and reception processing conforming to Wi-Fi® Display specifications. In mirroring conforming to Wi-Fi® Display specifications, the source apparatus operates as a transmission apparatus for transmitting (streaming) a stream of currently displayed screen information and/or currently reproduced audio information to the sink apparatus via a network. Then, the sink apparatus operates as a reception apparatus for receiving the stream of screen display and/or audio information received from the source apparatus and reproducing the data in synchronization with the source apparatus. More specifically, the screen currently displayed and/or the audio currently reproduced by the source apparatus are shared and reproduced by the source and sink apparatuses. Mirroring is not limited to Wi-Fi® Display and may conform to other specifications.

Specific examples of the communication apparatus 101 include a tablet, smart phone, personal computer (PC), mobile phone, camera, video camera, and other input apparatuses. However, the communication apparatus 101 is not limited thereto. Specific examples of the communication apparatus 102 include a tablet, smart phone, PC, mobile phone, television, head mounted display, projector, display, car navigation apparatus, and other output apparatuses. However, the communication apparatus 102 is not limited thereto.

The communication apparatus 101 (source apparatus) and the communication apparatus 102 (sink apparatus) are able to use the content redirection function. In the content redirection function, the source apparatus instructs the sink apparatus to acquire a content from an external apparatus other than the source apparatus and reproduce the content. In this case, the source apparatus transmits to the sink apparatus information required to instruct the sink apparatus to acquire a content from the external apparatus.

The required information is information of a content on the cloud server 104. The information of a content includes, for example, an identifier for identifying the content on the cloud server 104, service name, content location information (Uniform Resource Identifier (URI) and Uniform Resource Locator (URL)), and reproduction start time (offset). The information of a content to be received may be a part of these pieces of information. The identifier of a content is an identifier for uniquely determining the content. Based on the information of a content received from the communication apparatus 101, the communication apparatus 102 receives the content on the cloud server 104 via the access point 103 and then reproduces the content.

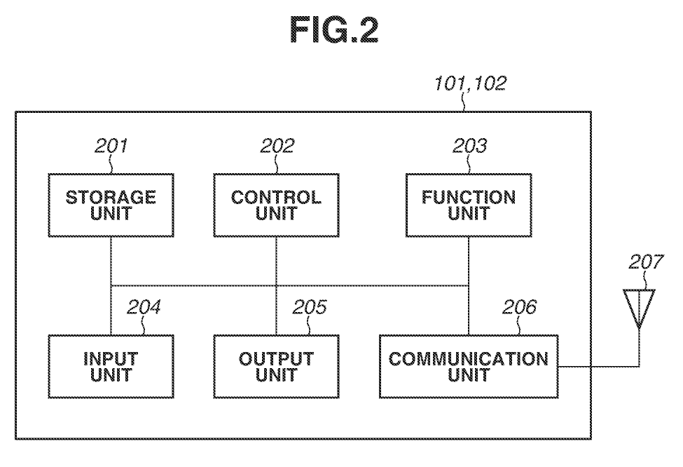

FIG. 2 illustrates a hardware configuration of the communication apparatus 101.

The communication apparatus 101 includes a storage unit 201, a control unit 202, a function unit 203, an input unit 204, an output unit 205, a communication unit 206, and an antenna 207.

The storage unit 201, including memories such as a ROM and RAM, stores various information such as programs for implementing various operations (described below) and communication parameters for wireless communication. In addition to memories such as a ROM and RAM, examples of storage media usable as the storage unit 201 include a flexible disk, hard disk, optical disc, magneto-optical disk, compact disc read only memory (CD-ROM), compact disc recordable (CD-R), magnetic tape, nonvolatile memory card, and digital versatile disc (DVD). The storage unit 201 can include a plurality of memories.

The control unit 202 includes a processor such as a central processing unit (CPU) and a micro processing unit (MPU) and controls the entire communication apparatus 101 by executing a program stored in the storage unit 201. The control unit 202 executes a program stored in the storage unit 201 to implement the mirroring function and the content redirection function as a source apparatus. The mirroring function as a source apparatus refers to a function of capturing a screen displayed by the self apparatus and then transmitting encoded screen data and encoded audio data to the sink apparatus. The content redirection function as a source apparatus refers to a function of transmitting, to the sink apparatus, information necessary for the sink apparatus to acquire a content to be reproduced by the sink apparatus from an external apparatus other than the source apparatus, and instructing the sink apparatus to reproduce the content. This instruction is not needed to be explicit. For example, if the sink apparatus that received information needed to acquire a content from the external apparatus automatically performs content redirection processing, the source apparatus needs only to transmit the needed information to the sink apparatus.

The control unit 202 may control the entire communication apparatus 101 in collaboration with a program stored in the storage unit 201 and an operating system (OS). The control unit 202 can be provided with a plurality of processors, such as a multi-core, and control the entire communication apparatus 101 by using these processors.

The control unit 202 also controls the function unit 203 to perform predetermined processing, such as image capturing and content browsing. The function unit 203 is a hardware component for allowing the communication apparatus 101 to perform predetermined processing. For example, if the communication apparatus 101 is a camera, the function unit 203 is an imaging unit for performing image capturing processing. In this case, the communication apparatus 101 displays data generated by the imaging unit on the screen via the output unit 205 and then transmits the data to another communication apparatus by using the mirroring function of the control unit 202, thereby implementing mirroring. Alternatively, the communication apparatus 101 can display data stored in the storage unit 201 of the communication apparatus 101 on the screen via the output unit 205 and then perform mirroring in a similar way.

The input unit 204 receives various operations from a user. The output unit 205 outputs various data to the user through a monitoring screen and a speaker. Outputs by the output unit 205 can include, in addition to screen display, an audio output on the speaker and a vibration output. By using a touch panel, the input unit 204 and an output destination of the output unit 205 may be implemented by one module.

The communication unit 206 controls wireless communication conforming to the IEEE 802.11 series, controls wired communication such as a wired LAN, and controls Internet Protocol (IP) communication. The communication unit 206 also controls the antenna 207 to transmit and receive wireless signals for wireless communication. The communication apparatus 101 transmits and receives a content, such as image data, document data, audio data, and video data to/from the communication apparatus 102 via the communication unit 206.

The communication apparatus 102 has a similar hardware configuration to the communication apparatus 101. The storage unit 201, the control unit 202, the function unit 203, the input unit 204, the output unit 205, and the antenna 207 of the communication apparatus 102 are similar to those of the communication apparatus 101, and redundant descriptions thereof will be omitted.

The control unit 202 of the communication apparatus 102 implements the mirroring function and the content redirection function as sink apparatus by executing a program stored in the storage unit 201. The mirroring function as a sink apparatus is a function of receiving encoded screen data (captured data of a screen displayed by the source apparatus) and/or encoded audio data, and decoding and reproducing the data. The content redirection function as a sink apparatus is a function of acquiring a content from an external apparatus other than the source apparatus based on information and instruction sent from the source apparatus, and reproducing the content. The sink apparatus can acquire and reproduce a content without an explicit instruction.

The communication unit 206 of the communication apparatus 102 has a concurrent connection function for allowing connection with a plurality of networks in parallel. The concurrent connection function allows the communication apparatus 102 communicate with the communication apparatus 101 via the network 111 and also communicate with the access point 103 via the network 110. However, conditions achieving the concurrent connections are determined based on the role of the communication apparatus 102 in the networks 110 and 111. In this case, the combination of roles of the communication apparatus 102 in each network, supported by the concurrent connection function of the communication apparatus 102, is determined to be a STA/GO.

STA refers to a Station which is an apparatus having a role of participating in a network established by an access point (AP). A network established by an AP refers to the network 110 established by the access point 103. GO refers to a Group Owner conforming to Wi-Fi® P2P specifications, which is an apparatus having a role of establishing a network. A network established by the GO refers to the network 111. In a Wi-Fi® P2P connection, an apparatus participating in the network established by a GO is referred to as a Client (CL).

A case where the combination of roles supported by the concurrent connection function is a STA/GO means that the concurrent connections are executable only when the communication apparatus 102 has the role of a STA in the network 110 and has the role of a GO in the network 111. Therefore, for example, when the communication apparatus 102 has the role of a CL in the network. 111, the communication apparatus 102 is unable to perform the concurrent connections to the networks 110 and 111. This is because the storage unit 201 of the communication apparatus 102 is unable to concurrently store connection information related to the roles of apparatuses (STA and CL) participating in the two different networks. Therefore, the concurrent connection function of the communication apparatus 102 is unable to perform the concurrent connections of a STA/CL.

Both the communication apparatuses 101 and 102 are capable of performing both image display and audio reproduction. However, both the communication apparatuses 101 and 102 can ones capable of performing either image display or audio reproduction.

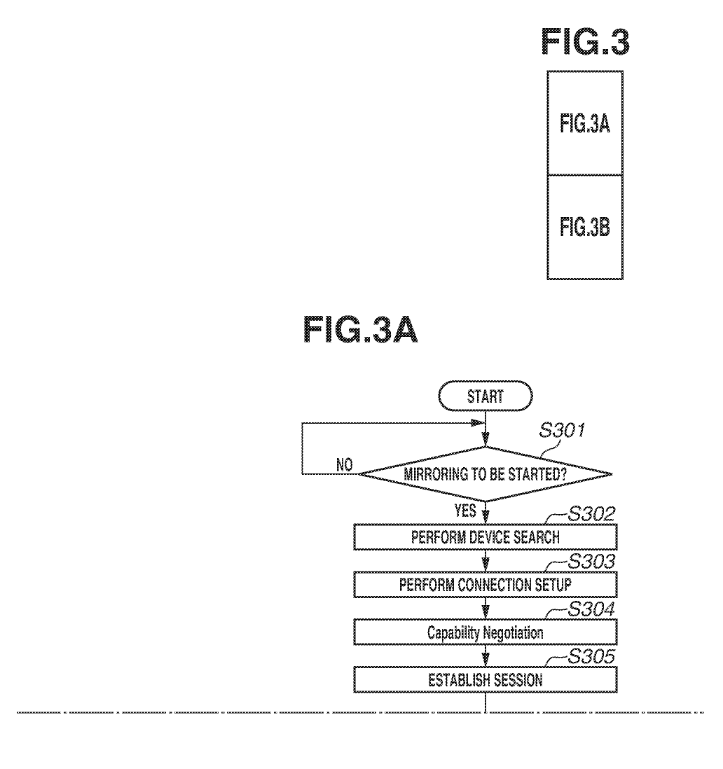

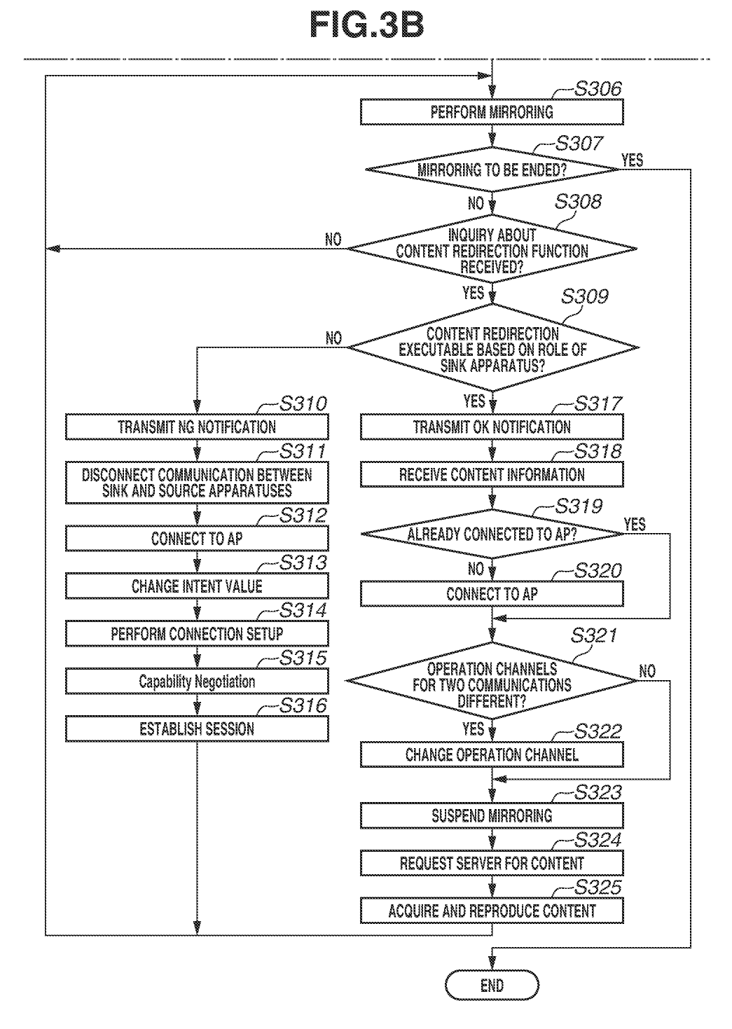

FIG. 3 is a diagram including the flowcharts of FIGS. 3A and 3B illustrating processing in which the sink apparatus (communication apparatus 102) performs content redirection. This processing is implemented when the control unit 202 reads a program stored in the storage unit 201 and then executes the program. This flowchart started in response to the activation of a predetermined application on the sink apparatus. The flowchart may be started when power of the sink apparatus is turned ON.

In step S301, the sink apparatus determines whether to start mirroring. More specifically, the sink apparatus determines whether a signal for starting mirroring is transmitted from the source apparatus. Alternatively, the sink apparatus can determine whether to start mirroring based on an input of a user operation for starting mirroring. In a case where the sink apparatus determines to start mirroring (YES step S301), the processing proceeds to step S302. On the other hand, in a case where the sink apparatus determines not to start mirroring (NO in step S301), the processing returns to step S301.

In step S302, the sink apparatus starts a device search. More specifically, the sink apparatus transmits a search signal (for example, Probe Request conforming to the IEEE 802.11 series). Upon reception of the search signal, the source apparatus (communication apparatus 101) transmits a response signal (for example, Probe Response conforming to the IEEE 802.11 series) for the search signal. The sink apparatus detects the source apparatus by receiving this response signal. The sink apparatus can detect the source apparatus by receiving a notification signal (for example, a beacon conforming to the IEEE 802.11 series) or a search signal (Probe Request) transmitted by the source apparatus.

The source apparatus also performs a device search in a similar way. Then, a list of devices detected by the source apparatus is displayed, and a connection partner apparatus is selected from the list. A connection partner apparatus can be selected on the sink apparatus.

The source apparatus can detect a connection partner apparatus by using NFC, Quick Response (QR) code®, Bluetooth Low Energy (BLE), etc. For example, if the source apparatus has an NFC communication function, it is also possible to perform pairing between the source and sink apparatuses via an NFC touch operation, and to perform subsequent communications based on Wi-Fi® Display specifications. Alternatively, the source apparatus can read a QR code displayed on the sink apparatus, obtain information needed to connect with the sink apparatus, and perform subsequent communications based on Wi-Fi® Display specifications. If the source apparatus has a BLE communication function, the source apparatus is also able to scan an apparatus supporting BLE, perform paring with the sink apparatus, and perform subsequent communications based on Wi-Fi® Display specifications. Not the source apparatus but the sink apparatus can detect a connection partner apparatus.

In step S303, the sink apparatus performs a connection setup. More specifically, the sink apparatus performs Wi-Fi® Display connection processing and then performs Transmission Control Protocol (TCP) connection processing. When these pieces of connection processing are performed, the connection setup is completed.

Although a method for establishing a Wi-Fi® Display connection can be selected from two different methods, Wi-Fi® P2P and Tunneled Direct Link Setup (TDLS), the present embodiment establishes a Wi-Fi® Display connection in conformance with Wi-Fi® P2P specifications.

Detailed procedure in step S303 will be described below. To determine a GO, the sink apparatus receives a GO Negotiation Request as a role determination request from the source apparatus. This signal includes an intent value which indicates the degree of the intention of the source apparatus to become a GO.

As a response to the GO Negotiation Request, the sink apparatus transmits a GO Negotiation Response. This signal includes an intent value of the sink apparatus. The source apparatus compares the intent values of the sink and source apparatuses. The apparatus having a larger intent value serves as a GO, and the apparatus having, a smaller intent value serves as a CL. The present embodiment will be described under assumption that the intent value of the source apparatus is larger than the intent value of the sink apparatus and that the source apparatus serves as a GO. Finally, when the sink apparatus receives a GO Negotiation Confirmation from the source apparatus, the role of the sink apparatus (GO or CL) is determined. In this case, the role of the sink apparatus is assumed to have been determined to be a CL. When the intent value of the sink apparatus is larger than the intent value of the source apparatus, the sink apparatus serves as a GO. Thus, the exchange of signals for determining a GO and CL is referred to as a GO Negotiation.

Subsequently, in conformance with Wi-Fi Protected Setup™ (WPS), the sink apparatus receives from the source apparatus information about connection and security and other parametric information needed to establish a network connection with the source apparatus. Then, the sink apparatus as a CL transmits an Association Request to the source apparatus as a GO by using the received parametric information. The sink apparatus receives from the source apparatus an Association Response as a response to the Association Request.

In this way, a Wi-Fi® Display connection conforming to Wi-Fi® P2P specifications, i.e., a Wi-Fi® P2P connection, is established between the sink and source apparatuses. The wireless signals transmitted by the source apparatus in the above-described embodiment can be transmitted by the sink apparatus, and the wireless signals transmitted by the sink apparatus in the above-described embodiment can be transmitted by the source apparatus. Further, wireless signals other than the above-described signals can be used in establishing a Wi-Fi® Display connection. More specifically, a Beacon, Reassociation message, P2P Invitation message, Provision Discovery message, etc. can be used.

Subsequently, the sink apparatus establishes a TCP connection with the source apparatus. This connection is established when the sink apparatus serves as a TCP client and performs Three-way handshaking with the source apparatus.

When a Wi-Fi® Display connection and a TCP connection are established in this way, the connection setup is completed.

Subsequently, in step S304, the sink apparatus performs a Capability Negotiation. Wi-Fi® Display specifications define that the Real Time Streaming Protocol (RTSP) is used for the Capability Negotiation. The RTSP is a protocol for controlling streaming. TCP is generally used as a transport protocol for a lower level layer. In the Capability Negotiation, the sink apparatus exchanges predetermined messages RTSP M1 to M4 with the source apparatus. Through the exchange of these RTSP messages, the sink apparatus provides the source apparatus with the capability information of the self apparatus (sink apparatus). Then, the source apparatus determines parameters to be used in mirroring based on the capability information of the sink apparatus, and notifies the sink apparatus of the parameters. The sink apparatus sets the notified parameters.

The capability information includes, for example, information about the capability of the screen of the sink apparatus, such as the resolution of a corresponding screen, frame rate, and codec. Example capability information includes information about the audio processing of the sink apparatus, i.e., applicable codec and sampling frequency. As a result of the Capability Negotiation in steps S307 and S308, parameters are set to the sink apparatus, and a screen, audio encoding method, video resolution, frame rate, etc. to be used when the sink apparatus performs mirroring with the source apparatus are determined. Information about transmission and reception capabilities can be a part of these pieces of information. The parameters notified from the source apparatus and set by the sink apparatus can include not only parameters to be used in mirroring but also parameters related to other functions, such as content redirection.

When the Capability Negotiation is completed, then in step S305, the sink apparatus establishes a Wi-Fi® Display session with the source apparatus. More specifically, in conformance with Wi-Fi® Display specifications, the sink apparatus establishes a Wi-Fi® Display session by exchanging predetermined messages RTSP M5 to M7 with the source apparatus. Through the exchange of these RTSP messages, both the source and sink apparatuses set a port number to be used in mirroring, and a Wi-Fi® Display session is established. In establishing a Wi-Fi® Display session, the sink apparatus can set a port number to be used in other functions, such as content redirection. A plurality of port numbers can be set.

After completion of RTSP message exchange in up to step S305, then in step S306, the sink apparatus performs mirroring. The mirroring processing by the sink apparatus includes data reception, demultiplexing, captured image decoding, and reproduction of the decoded captured image. Through such mirroring processing, the sink apparatus receives a stream of information of the screen currently displayed and/or the audio currently reproduced by the source apparatus (screen and/or audio stream), and reproduces the stream.

During execution of mirroring, in step S307, the sink apparatus determines whether to end mirroring. More specifically, the sink apparatus performs this determination based on whether a signal indicating the end of mirroring is transmitted from the source apparatus. The sink apparatus can perform this determination based on a user operation input to the sink apparatus. Alternatively, the sink apparatus can perform this determination based on the communication quality of the source or sink apparatus in the communication between these apparatuses and the residual quantity of the battery of at least one of the source and sink apparatuses. In a case where the sink apparatus determines to end mirroring (YES in step S307), this flowchart ends. On the other hand, in a case where the sink apparatus determines not to end mirroring (NO in step S307), the processing proceeds to step S308.

In step S308, the sink apparatus determines whether an inquiry about the content redirection function is received. In a case where the inquiry is not received (NO in step S308), the processing returns to step S306. In step S306, the sink apparatus continues the mirroring processing. On the other hand, in a case where the inquiry is received (YES in step S308), the processing proceeds to step S309. In step S309, the sink apparatus determines whether content redirection is executable.

In this case, the sink apparatus determines whether content redirection is executable based on which of the roles GO and CL the sink apparatus has been assigned in the GO Negotiation performed in step S303. The following describes the reason why the determination is performed in this way.

In content redirection, since the sink apparatus needs to acquire a content from an external apparatus (cloud server 104), the sink apparatus communicates with the external apparatus via the access point 103. In this case, the sink apparatus needs to connect to the access point 103 (AP) as a station (STA). In this case, as illustrated in FIG. 2, the combination of roles supported by the concurrent connection function of the sink apparatus is predetermined to be a STA/GO. Therefore, in a case where the sink apparatus does not serve as a GO in the network 111, the sink apparatus unable to perform content redirection while maintaining the connection with the source apparatus.

Therefore, the sink apparatus performs the determination in this step based on the role of the sink apparatus in the communication with the source apparatus in the network 111. The role of the sink apparatus in the communication with the source apparatus has been determined to be a CL in step S303. Therefore, the sink apparatus is unable to perform the concurrent connections with the source apparatus and the access point 103, and therefore determines that content redirection is not executable (NO in step S309). On the other hand, in a case where the role of the sink apparatus in the communication with the source apparatus a GO, the sink apparatus determines that content redirection is executable (YES in step S309).

The sink apparatus can perform the determination in step S309 based on whether the role of the sink apparatus is a GO or CL as described above, or by acquiring the combinations of the roles supported by the concurrent connection function of the sink apparatus and performing comparison with the acquired combinations.

The sink apparatus can also perform the determination in step S309 by determining whether there is an application applicable to content redirection out of applications of the sink apparatus. Alternatively, the sink apparatus can perform the determination in step S309 by determining whether the execution of content redirection by the sink apparatus is permitted as a setting of the sink apparatus. The sink apparatus can also perform the determination in step S309 based on the combination of these determination bases.

According to the present embodiment, in a case where the sink apparatus determines that the inquiry about the content redirection function is received (YES in step S308), then in step S309, the sink apparatus determines whether content redirection is executable. However, the processing is not limited thereto. The sink apparatus can perform this determination at any timing after determining the role of the sink apparatus in the GO Negotiation in step S303. In this case, after receiving an inquiry about the content redirection function in step S308, then in step S309, the sink apparatus can select “YES” or “NO” based on the result of the determination that has already been performed.

In a case where the sink apparatus determines that content redirection is not executable (NO in step S309), then in step S310, the sink apparatus transmits an NG notification to the source apparatus as a response to the inquiry received in step S308. This notification can include only information indicating NG or include information about the reason why content redirection is not executable and information about an application capable of performing content redirection out of applications of the sink apparatus. At any timing after step S302, the sink apparatus can notify the source apparatus of the information about an application capable of performing content redirection out of applications of the sink apparatus.

In step S311, the sink apparatus disconnects the communication between the sink and source apparatuses. More specifically, the sink apparatus issues and transmits a RTSP TEARDOWN message conforming to Wi-Fi® Display specifications. As a result, the communication between the sink and source apparatuses is disconnected. More specifically, the Wi-Fi® Display session is disconnected. In this case, the TCP connection and the Wi-Fi® P2P connection between the sink and source apparatuses can be disconnected. Alternatively, when a TDLS connection conforming to TDLS is performed as a Wi-Fi® Display connection, the TDLS connection is disconnected in lieu of the Wi-Fi® P2P connection. Upon reception of a RTSP SET_PARAMETER message from the source apparatus, the sink apparatus can issue and transmit a RTSP TEARDOWN message. Further, the sink apparatus can transmit the RTSP TEARDOWN message in step S311, omitting the NG notification in step S310.

In step S312, the sink apparatus that disconnected the communication with the source apparatus establishes a communication with the access point 103. In step S313, the sink apparatus changes its own intent value. More specifically, the sink apparatus sets the intent value to 15 to become a GO. Since the intent value of the sink apparatus needs to be larger than the intent value of the source apparatus, an integer between 0 and 15, larger than the intent value of the source apparatus needs to be set as the intent value of the sink apparatus.

In step S314, the sink apparatus performs the connection setup. This step is similar to step S303. When the intent value of the sink apparatus is changed in step S313, the result of the GO Negotiation is that the sink apparatus is set as a GO and the source apparatus is set as a CL.

In step S315, the sink apparatus performs the Capability Negotiation. In step S316, the sink apparatus establishes a session. Steps S315 and S316 are similar to steps S304 and S305, respectively. Although, in steps S313 to S315, the sink apparatus exchanges predetermined signals with the source apparatus, the sink apparatus can suitably omit exchange of omissible signals. The sink apparatus sets the operation channel for the communication with the source apparatus established in steps S314 to S316 to the same operation channel as the one for the communication with the access point 103 established in step S312. This is because the sink apparatus may fail to receive data if the operation channel for the communication with the source apparatus is different from the operation channel for the communication with the access point 103.

When a session has been established, the processing returns to step S306. In step S306, the sink apparatus performs the mirroring processing. In step S307, the sink apparatus determines whether mirroring is completed. In a case where the sink apparatus determines that mirroring is not completed (NO in step S307), the processing proceeds to step S308. In step S308, the sink apparatus determines whether an inquiry about the content redirection function is received. In a case where the inquiry is received (YES in step S308), the processing proceeds to step S309. In step 8309, the sink apparatus determines whether content redirection is executable.

According to the present embodiment, the concurrent connection function of the sink apparatus supports the concurrent connections with the combination “STA/GO”. Since the role of the sink apparatus is set as a GO in step S313, the sink apparatus is able to perform the concurrent connections. Therefore, based on the role of the sink apparatus, the sink apparatus determines that content redirection is executable (YES in step S309).

In a case where the sink apparatus determines that content redirection is executable (YES in step S309), the processing proceeds to step S317. In step S317, the sink apparatus transmits an OK notification to the source apparatus. This notification can include information about an application capable of performing content redirection out of applications of the sink apparatus. Alternatively, the notification can include information about whether a predetermined application of the sink apparatus is able to perform content redirection.

In step S318, the sink apparatus receives information of a content from the source apparatus. The information of a content received includes, for example, an identifier for identifying a content on the cloud server 104, service name, content location information (URI and URL), and reproduction start time (offset). The information of a content to be received can be a part of these pieces of information. Further, a RTSP SET_PARAMETER message is used for a notification of content information.

In step S319, the sink apparatus determines whether the sink apparatus has connected to the access point 103 to perform content redirection. Example cases where the sink apparatus has connected to the access point 103 include a case where the sink apparatus connects to the access point 103 in step S312 and a case where the sink apparatus connects to the access point 103 before or during execution of mirroring.

In a case where the sink apparatus is determined to have connected to the access point 103 (YES in step S319), the processing proceeds to step S321. On the other hand, in a case where the sink apparatus is determined to have not connected to the access point 103 (NO in step 3319), the processing proceeds to step S320. In step S320, the sink apparatus establishes a connection to the access point 103, and the processing proceeds to step S321. The sink apparatus can perform steps S319 and S320 before step S317.

In step S321, the sink apparatus determines whether the operation channel for the communication with the source apparatus is different from the operation channel for the communication with the access point 103. In a case where the operation channels for the two communications are not different from each other (NO in step S321), the processing proceeds to step S323. On the other hand, in a case where the operation channels for the two communications are different from each other (YES in step S321), the processing proceeds to step S322. In step S322, the sink apparatus changes the operation channel for the communication with the source apparatus. Then, the processing proceeds to step S323.

In step S323, the sink apparatus that has prepared to start content redirection the above-described processing in up to step S322 suspends the currently executing mirroring processing. When performing content redirection during execution of mirroring, suspending the mirroring processing allows reducing the load of the mirroring processing on the sink apparatus and restricting power consumption. In this case, the Wi-Fi® Display connection (P2P connection or TCP connection) is maintained between the source and sink apparatuses.

In step S324, the sink apparatus requests the cloud server 104 for a content based on the information of the content received in step S318. At this timing, the sink apparatus as a STA connects to the access point 103. In step S325, the sink apparatus acquires the content from the cloud server 104 and then reproduces the content. In this case, the sink apparatus acquires the content from the cloud server 104 via the access point 103. Various content acquisition methods and protocols are used depending on types of contents and types of services. For example, the HTTP Live Streaming (HLS) method and the GET method of HyperText Transfer Protocol (HTTP) can be used.

The sink apparatus that has reproduced a content in step S325 resumes mirroring in step S306. Alternatively, the processing can return to step S301, and the sink apparatus can wait until mirroring is started. The processing can return to step S318, and the sink apparatus can receive information of a new content from the source apparatus. In this case, the processing can skip steps S319 to S323. Alternatively, while acquiring and reproducing a content in step S325, the sink apparatus can receive information of a new content from the source apparatus. Then, after completion of the reproduction of the content, the processing returns to step S324, and the sink apparatus can request the cloud server 104 for a new content.

The flowchart illustrated in FIG. 3 indicates processing performed by the sink apparatus when content redirection is performed.

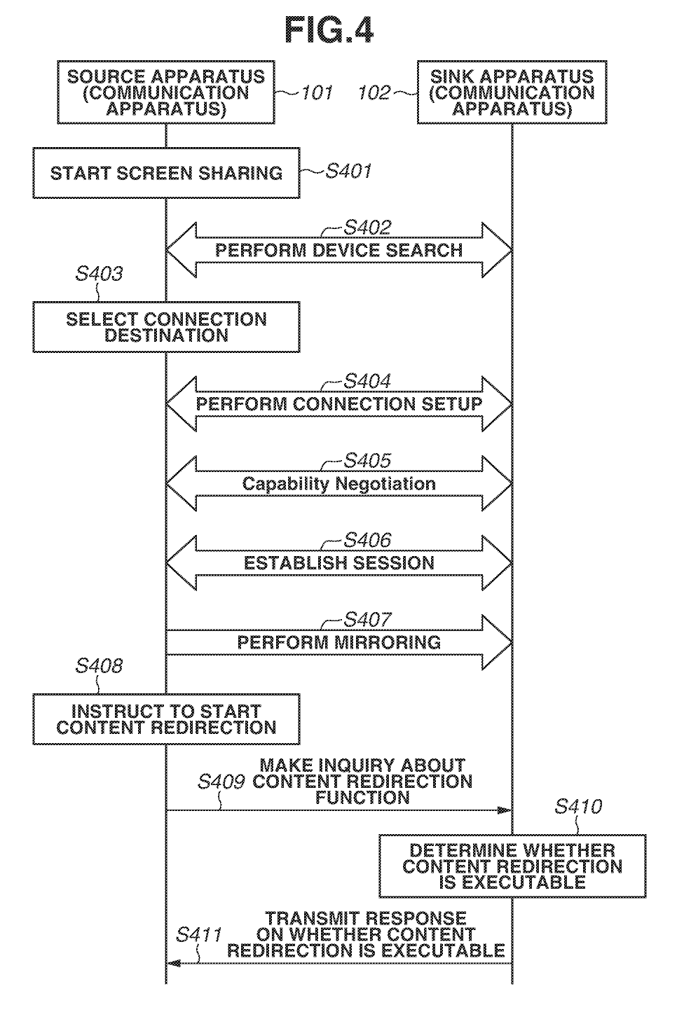

In the sequence diagrams illustrated in FIGS. 4 to 6, the sink apparatus operates according to the procedure of the flowchart illustrated in FIG. 3.

FIG. 4 is a sequence diagram implemented by the communication apparatus 101 (source apparatus) and the communication apparatus 102 (sink apparatus) to perform mirroring.

In step S401, the user performs an operation for starting the sharing of screen and/or audio on the input unit 204 of the source apparatus. Examples of the starting operation include pressing a control button for starting the sharing of screen and/or audio by the user, activating a predetermined application, or starting the reproduction of a predetermined content.

When a start operation is performed, then in step S402, the source and sink apparatuses perform a device search. Through the device search, the source and sink apparatuses detect each other. In step S403, the source apparatus displays a list of devices detected by the source apparatus, and the user selects a connection partner apparatus (sink apparatus) from the device list.

In step S404, the source apparatus and the sink apparatus selected in step S403 perform the connection setup. More specifically, the source and sink apparatuses perform Wi-Fi® Display connection processing, and then TCP connection processing. When connection processing is performed, the connection setup is completed. In this case, as determined in step S303 illustrated in FIG. 3, the source apparatus is assumed to become a GO and the sink apparatus a CL.

In step S405, the source and sink apparatuses perform the Capability Negotiation. When the Capability Negotiation is completed, then in step S406, the source and sink apparatuses establish a Wi-Fi® Display session. These pieces of processing are completed when the two apparatuses exchange RTSP messages, as described above.

When the RTSP message exchange in up to step S406 is completed and a Wi-Fi® Display session is established, then in step S407, the source and sink apparatuses perform the mirroring processing.

In step S408, the user issues an instruction for starting content redirection via the input unit 204 of the source apparatus. Examples of an instruction for starting content redirection include an operation in which the user selects a content (on the cloud server 104) as a service target of content redirection on the source apparatus. Alternatively, this start instruction can be assumed when the user inputs information necessary for the sink apparatus to identify a content, when the user performs a specific operation during reproduction of a content, or when the user activates a predetermined application.

When the user issues an instruction for starting content redirection, then in step S409, the source apparatus transmits an inquiry about the content redirection function to the sink apparatus. Upon reception of the inquiry, then in step S410, the sink apparatus determines whether content redirection is executable. The determination of whether content redirection is executable by the sink apparatus as described in step S309 illustrated in FIG. 3.

In step S411, in response to the inquiry in step S409, the sink apparatus transmits to the source apparatus information about whether content redirection is executable and information about an application capable of performing content redirection out of applications of the sink apparatus.

The sequence diagram illustrated in FIG. 4 indicates processing performed by the source and sink apparatuses to implement mirroring.

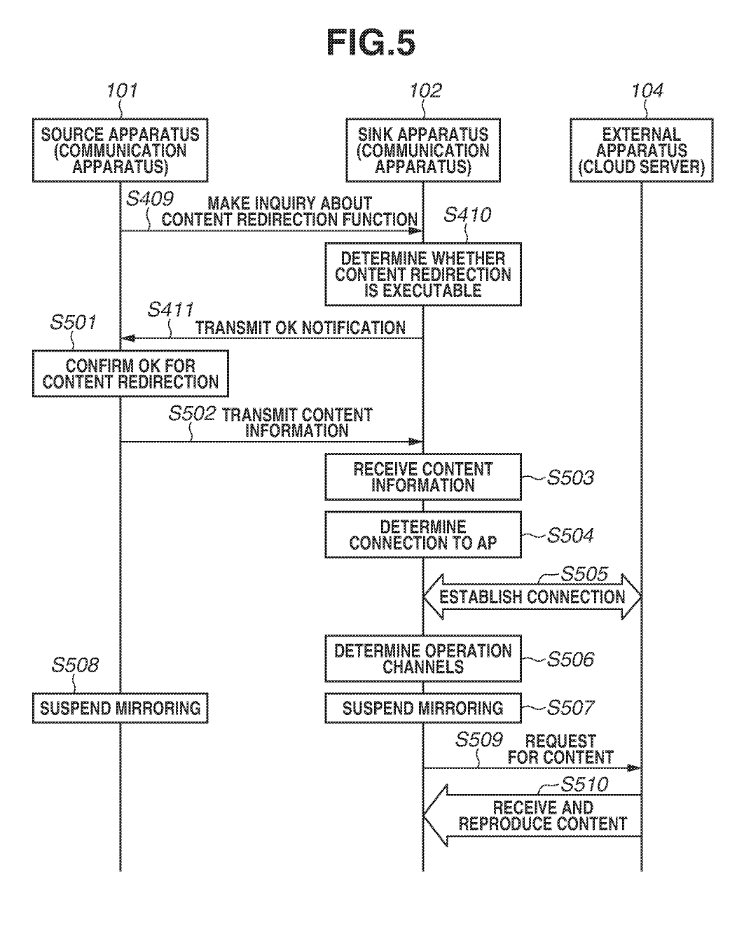

FIG. 5 is a sequence diagram implemented by the communication apparatus 101 (source apparatus), the communication apparatus 102 (sink apparatus), and the cloud server 104 (external apparatus) when content redirection is determined to be executable based on the role of the sink apparatus. As a preliminary step for this sequence diagram, processing in steps S401 to S408 illustrated in FIG. 4 is completed. This sequence will be described under assumption that the role of the source apparatus has been determined to be a CL and the role of the sink apparatus has been determined to be a GO in the GO Negotiation in step S404 illustrated in FIG. 4. The sink apparatus in this sequence diagram is assumed to have the concurrent connection function, support the concurrent connections with a combination “STA/GO”, and have not connected to the access point 103.

In step S409, the source apparatus transmits an inquiry about the content redirection function to the sink apparatus. Upon reception of the inquiry, then in step S410, the sink apparatus determines whether content redirection is executable. The method for determining whether content redirection is executable by the sink apparatus is as described above with reference to step S309 illustrated in FIG. 3. Since the sink apparatus has been determined as a GO in the GO Negotiation, the determination result in step S410 is “YES”.

In step S411, the sink apparatus transmits an OK notification for content redirection to the source apparatus. In step S501, the source apparatus confirms the OK information for content redirection. In step S502, the source apparatus transmits content information to the sink apparatus. In step S503, the sink apparatus receives the content information. In step S504, the sink apparatus determines whether the self apparatus (the sink apparatus) has connected to the access point 103. Since the sink apparatus in this sequence diagram has not connected to the access point 103, the determination result in step S504 is “NO”. In step S505, the sink apparatus establishes a connection with the access point 103. In step S506, the sink apparatus determines whether the operation channel for the communication with the access point 103 is different from the operation channel for the communication with the source apparatus. In this sequence diagram, since the operation channel for the communication with the access point 103 is not different from the operation channel for the communication with the source apparatus, the determination result in step S506 is “NO”.

In step S507, the sink apparatus that has prepared for content redirection suspends mirroring. In step S508, the source apparatus also suspends mirroring. When mirroring is suspended, then in step S509, the sink apparatus requests the external apparatus for a content via the connected access point 103. In step S510, the sink apparatus receives a content from the external apparatus and reproduces the content.

The sequence diagram illustrated in FIG. 5 indicates processing performed by each apparatus when content redirection is determined to be executable based on the role of the sink apparatus.

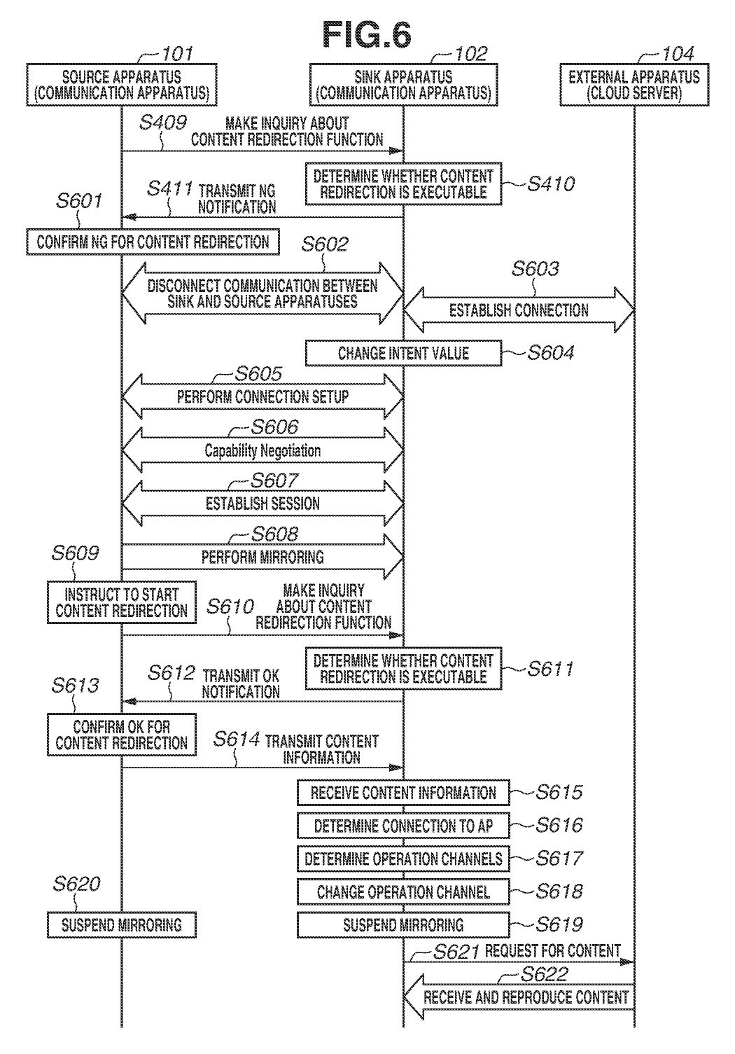

FIG. 6 is a sequence diagram implemented by the communication apparatus 101 (source apparatus), the communication apparatus 102 (sink apparatus), and the cloud server 104 (external apparatus) when content redirection is determined to be not executable based on the role of the sink apparatus. This sequence will be described under assumption that the role of the source apparatus has been determined to be a GO and the role of the sink apparatus has been determined to be a CL in the GO Negotiation in step S404 illustrated in FIG. 4. The sink apparatus in this sequence diagram is assumed to have the concurrent connection function, support the concurrent connections with a combination “STA/GO”, and have not connected to the access point 103.

In step S409, the source apparatus transmits an inquiry about the content redirection function to the sink apparatus. Upon reception of the inquiry, then in step S410, the sink apparatus determines whether content redirection is executable. The method for determining whether content redirection is executable by the sink apparatus is as described above with reference to step S309 illustrated in FIG. 3. Since the sink apparatus has been determined as a CL in the GO Negotiation, the determination result in step S410 is “NO”.

The sink apparatus has determined that content redirection is not executable in step S410, then in step S411, the sink apparatus transmit an NG notification to the source apparatus. In step S601, the source apparatus confirms the NG information for content redirection.

In step S602, the communication between the sink and source apparatuses is disconnected. In a case where the sink apparatus has determined that content redirection is not executable in step S410, the sink apparatus can prompt the user to select whether to disconnect the communication between the sink and source apparatuses before disconnecting the communication in step S602. More specifically, the sink apparatus can display a notification for making an inquiry to the user about whether to disconnect and reconnect the communication between the sink and source apparatuses, via the output unit 205 of the sink apparatus, if the sink apparatus has determined that content redirection is not executable in step S410. Then, in a case where the user selects to disconnect and disconnect the communication, the sequence after step S602 can be performed. On the other hand, in a case where the user selects not to disconnect and reconnect the communication, mirroring can be continued. Alternatively, the source apparatus can acquire a content to be reproduced through content redirection from the external apparatus, reproduce the content, and transmit the content to the sink apparatus through mirroring.

Yet alternatively, when the source apparatus receives the NG notification for content redirection in step S411, the source apparatus prompts the user to select whether to disconnect the communication. More specifically, when the source apparatus confirms the NG notification in step S601, the source apparatus can display a notification for making an inquiry to the user about whether to disconnect and reconnect the communication between the sink and source apparatuses, via the output unit 205 of the source apparatus. In this case, even if a RTSP TEARDOWN message is transmitted from the sink apparatus, the source apparatus returns a response other than RTSP OK. More specifically, in response to a RTSP TEARDOWN message, the source apparatus returns a response for rejecting the disconnection of the Wi-Fi® Display session to the sink apparatus.

Then, when the user selects to disconnect and reconnect the communication, the source apparatus transmits to the sink apparatus a RTSP SET_PARAMETER message for requesting for the transmission of a RTSP TEARDOWN message. Thus, the source apparatus retransmits a RTSP TEARDOWN message to the sink apparatus, and the Wi-Fi® Display session between the sink and source apparatuses is disconnected.

On the other hand, in a case where the user selects not to disconnect and reconnect the communication, mirroring is continued. Alternatively, the source apparatus can acquire a content to be reproduced through content redirection from the external apparatus, reproduce the content, and transmit the content to the sink apparatus through mirroring.

It is also possible to preset whether to disconnect and reconnect the communication based on the determination of whether content redirection is not executable or based on a user selection. This setting can be predetermined in an initial setting or can be set by the user.

Alternatively, it is also possible to set whether to disconnect and reconnect the communication between the sink and source apparatuses based on the type of content, processing loads on the source and sink apparatuses, and the traffic amount of the communication between the source and sink apparatuses.

When the communication between the sink and source apparatuses is disconnected, then in step S603, the sink apparatus establishes a communication with the access point 103. In step S604, the sink apparatus changes the intent value to become a GO. In step S605, the sink and source apparatuses perform the connection setup. Since the intent value of the sink apparatus has been changed in step S603, the sink apparatus serves as a GO and the source apparatus serves as a CL, as a result of the GO Negotiation. In step S606, the sink and source apparatuses perform the Capability Negotiation. In step S607, the sink and source apparatuses establish a session. When establishing a communication with the source apparatus by performing steps S605 to S607, the sink apparatus matches the operation channel for the communication with the source apparatus with the operation channel for the communication with the access point 103 established in step S603.

When a session has been established, then in step S608, the source and sink apparatuses perform mirroring. When mirroring is started, then in step S609, the source apparatus issues an instruction for starting content redirection input by the user via the input unit 204 of the source apparatus. This step is similar to step S408 illustrated in FIG. 4. In step S610, the source apparatus transmits an inquiry about the content redirection function to the sink apparatus. This step is similar to step S409 illustrated in FIG. 4.

Upon reception of the inquiry about the content redirection function, then in step S611, the sink apparatus determines whether content redirection is executable based on the role of the sink apparatus. The determination method is similar to that in step S410 illustrated in FIG. 4. Since the role of the sink apparatus is a GO as a result of the GO Negotiation performed in step S605, the determination result in step S611 is “YES”.

In step S612, the sink apparatus transmits an OK notification to the source apparatus. Steps S613 to S615 are similar to steps S501 to S503 illustrated in FIG. 5, respectively. In step S616, the sink apparatus determines whether the self apparatus (sink apparatus) has connected to the access point 103. Since the sink apparatus has connected to the access point 103, the determination result in step S616 is “YES”.

In step S617, the sink apparatus determines whether the operation channel for the communication with the source apparatus is different from the operation channel for the communication with the access point 103. This sequence diagram is described under assumption that the operation channels for the two communications are different from each other. In the determination in step S617, the result is “YES”. In step S618, the sink apparatus changes the operation channel for the communication with the source apparatus to the same operation channel as the one for the communication with the access point 103. Steps S619 to S622 perform similar processing to steps S507 to S510 illustrated in FIG. 5, respectively.

The sequence diagram illustrated in FIG. 6 indicates processing performed by each apparatus in a case where content redirection is determined to be not executable based on the role of the sink apparatus.

Combinations of roles supported by the concurrent connection function of the sink apparatus can include STA/CL, STA/GO&CL, AP/GO, AP/CL, AP/GO&CL, and AP&STA/GO&CL. STA/GO&CL means that, when the sink apparatus serves as a STA in the communication with the access point 103, the concurrent connections are possible regardless of whether the sink apparatus serves as a GO or CL in the communication with the source apparatus. According to the combination of roles supported by the concurrent connection function of the sink apparatus, it is possible to suitably change the basis of the determination of whether content redirection in step S309 illustrated in FIG. 3 is executable.

Although, in the present embodiment, the sink apparatus determines whether the operation channel for the communication with the source apparatus is different from the operation channel for the communication with the access point 103, the determination does not need to be performed. In this case, the processing needs to skip steps S321 and S322 in the flowchart illustrated in FIG. 3.

According to the present embodiment, in a case where the communication between the sink and source apparatuses is disconnected and reconnected, the sink apparatus returns to the mirroring processing. More specifically, referring to FIG. 3, the processing returns to step S306 from step S316. In this case, an inquiry about the content redirection function for which the sink apparatus waits in step S308 is transmitted from the source apparatus based on a user operation input via the source apparatus. However, the source apparatus can automatically transmit an inquiry about the content redirection function if the sink apparatus selects “NO” for the determination in step S309.

More specifically, a predetermined signal can be transmitted from the sink apparatus to the source apparatus. This signal includes an instruction for transmitting an inquiry about the content redirection function to the sink apparatus after disconnecting and reconnecting the communication between the sink and source apparatuses. The predetermined signal can be transmitted from the sink apparatus to the source apparatus at any timing in steps S310 to S316. Alternatively, the instruction can be included in the NG notification in step S310. Yet alternatively, upon reception of the NG notification transmitted from the sink apparatus in step S310, the source apparatus can automatically transmit an inquiry about the content redirection function when the communication with the sink apparatus is reconnected. The source apparatus can automatically transmit an inquiry about the content redirection function based on information about the reason why content redirection is not executable included in the NG notification in step S310. In any case, the source apparatus can skip a user instruction for transmitting an inquiry about the content redirection function.

Although, in the present embodiment, the sink apparatus changes its intent value, the processing is not limited thereto. The source apparatus can change its intent value after receiving the NG information for content redirection in step S411. For example, if the concurrent connection function of the sink apparatus supports the combination “STA/GO” and the sink apparatus serves as a CL, the source apparatus can change its intent value to a value smaller than that of the sink apparatus.

Alternatively, both the sink and source apparatuses can change the respective intent values. For example, if the concurrent connection function of the sink apparatus supports the combination “STA/GO”, the intent value of the sink apparatus can be increased while decreasing the intent value of the source apparatus.

In steps S313 and S604, the sink apparatus does not change its intent value but can operate as an Autonomous GO. In this case, when the sink apparatus (GO) transmits a Beacon, the connection setup with the source apparatus (CL) is started, and the GO Negotiation is not performed in the connection setup in step S313.

The processing is not limited thereto. The connection setup can be started when the sink apparatus (GO) transmits an Invitation Request, and the source apparatus (CL) transmits an Invitation Response as a response. Further, if the concurrent connection function of the sink apparatus supports the combination “STA/CL”, the source apparatus does not change its intent value but can set the self apparatus as a GO.

The processing procedure of the sequence diagrams for the communication apparatus 101 illustrated in FIGS. 4 to 6 are implemented when the control unit 202 reads a program stored in the storage unit 201 of the communication apparatus 101 and then executes the program. The processing procedure of the sequence diagram of the communication apparatus 102 is implemented when the control unit 202 reads a program stored in the storage unit 201 of the communication apparatus 102 and then executes the program. At least a part or whole of the processing procedure of the sequence diagrams illustrated in FIGS. 4 to 7 can be implemented by hardware. When processing procedure of a sequence diagram is implemented by hardware, for example, a dedicated circuit is generated on a Field Programmable Gate Array (FPGA) based on a program for implementing each step by using a predetermined compiler, and then the circuit is used. Similar to the FPGA, the sequence diagram can be implemented by hardware, i.e., also by forming a Gate Array circuit. The sequence diagram can be implemented also by using an Application Specific Integrated Circuit (ASIC). This also applies to the processing procedure of the flowchart of the communication apparatus 102 illustrated in FIG. 3.

Each step of the sequence diagrams and flowcharts illustrated in FIGS. 3 to 6 can be implemented by a plurality of CPUs and apparatuses (not illustrated) in a distributed way. When implementing each step by a plurality of apparatuses in a distributed way, the source and sink apparatuses operate as a source and a sink system, respectively.

According to the first embodiment, if content redirection is not executable based on the role of the sink apparatus in the two communications, the role of the sink apparatus has been changed to make content redirection executable. More specifically, when performing content redirection, the sink apparatus needs to concurrently perform both the communication with the access point 103 and the communication with the source apparatus. For example, when the sink and source apparatuses connect through Wi-Fi Direct® and the sink apparatus is operating as a CL, the sink apparatus needs to operate also as a STA to connect to the access point 103. However, if the sink apparatus is unable to operate as a STA/CL, the concurrent connections are not possible. Therefore, if the sink apparatus determines that content redirection is not executable based on the role of the self apparatus, the sink apparatus disconnects the communication with the source apparatus and then reconnects with the source apparatus by setting the role of the self apparatus as a GO. As a result, the concurrent connections with both source apparatus and the access point 103 become possible, whereby content redirection becomes executable.

The network configuration of the communication system according to a second embodiment is similar to that illustrated in FIG. 1. According to the present embodiment, the hardware configuration of the communication apparatus 101 is as illustrated in FIG. 2, and similar to that of the communication apparatus 101 according to the first embodiment.

The communication apparatus 102 has a similar hardware configuration to that of the communication apparatus 101. Since the storage unit 201, the control unit 202, the function unit 203, the input unit 204, the output unit 205, and the antenna 207 of the communication apparatus 102 are similar to those of the communication apparatus 101, redundant descriptions thereof will be omitted.

The control unit 202 of the communication apparatus 102 implements the mirroring function and the content redirection function as sink apparatus by executing a program stored in the storage unit 201. The mirroring function as a sink apparatus is a function of receiving encoded screen data (captured data of a screen currently displayed by the source apparatus) and/or encoded audio data, and decoding and reproducing the data. The content redirection function as a sink apparatus is a function of acquiring a content from an external apparatus other than the source apparatus based on information and an instruction transmitted from the source apparatus, and reproducing the content. The sink apparatus can acquire and reproduce a content without an explicit instruction.

The communication unit 206 of the communication apparatus 102 has a concurrent connection function for allowing connection with a plurality of networks in parallel. The concurrent connection function allows the communication apparatus 102 to communicate with the communication apparatus 101 via the network 111 and also communicate with the access point 103 via the network 110. However, when communications are concurrently performed with the communication apparatus 101 and the access point 103, and if the operation channels for the two communications are different from each other, the communication apparatus 102 transmits and receives data while switching the operation channel of the self apparatus (communication apparatus 102) on a time division basis. More specifically, the communication apparatus 102 receives data from each apparatus while switching the operation channel of the self apparatus (communication apparatus 102) on a time division basis. In this case, the communication apparatus 102 can fail to receive data. Therefore, a case where the operation channels for the two communications are different from each other is not suitable for the execution of content redirection.

The communication apparatuses 101 and 102 are capable of performing both image display and audio reproduction. However, both the communication apparatuses 101 and 102 are capable of performing either image display or audio reproduction.

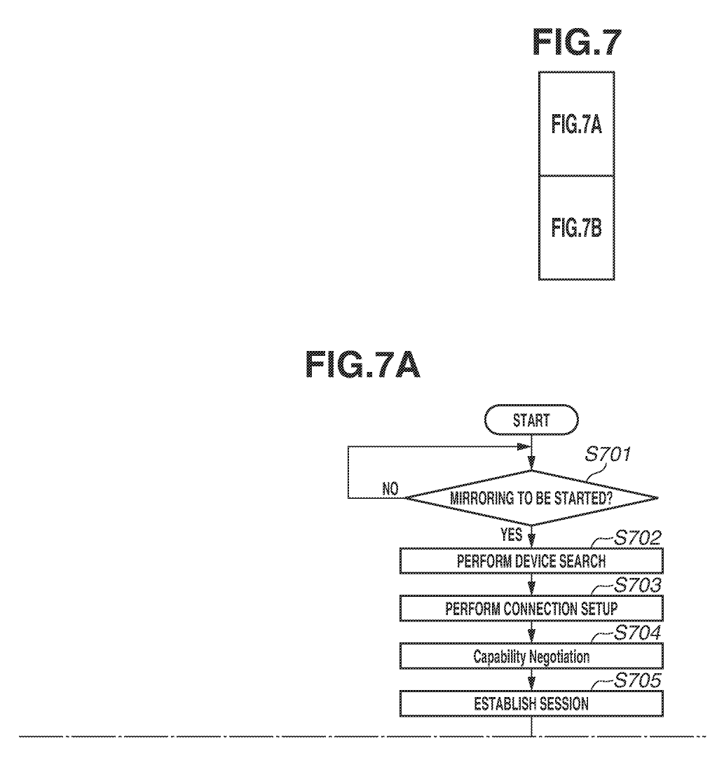

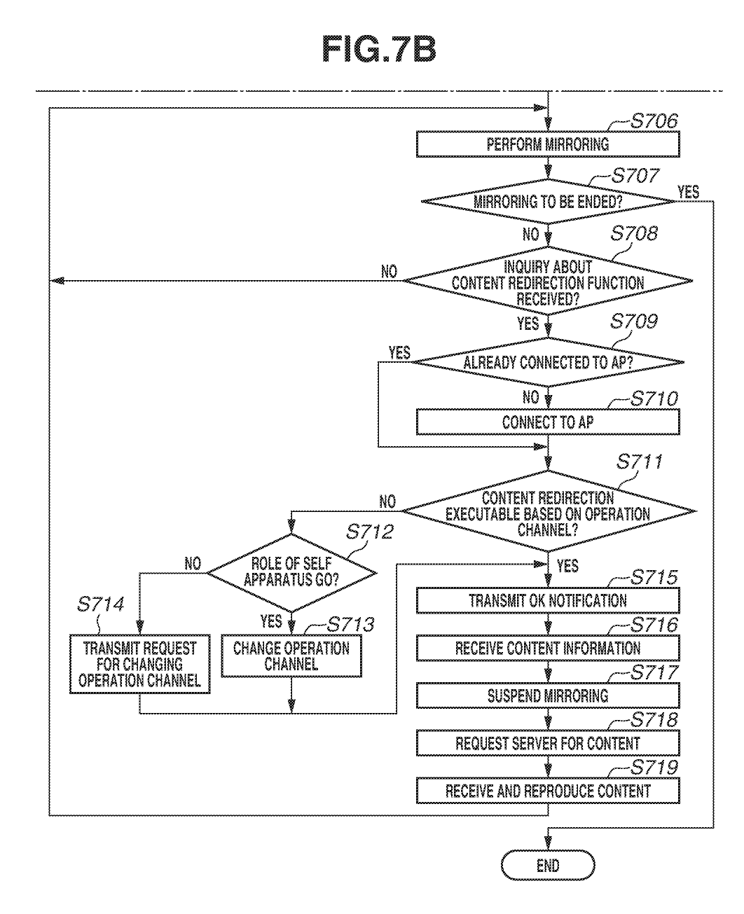

FIG. 7 is a diagram including the flowcharts of FIGS. 7A and 7B illustrating processing in which the communication apparatus 102 (sink apparatus) performs content redirection. This processing is implemented when the control unit 202 reads a program stored in the storage unit 201 and then executes the program. This flowchart is started in response to the activation of a predetermined application on the sink apparatus. The flowchart can be started when power of the sink apparatus is turned ON.

Steps S701 to S707 are similar to steps S301 to S307 illustrated in FIG. 3, respectively.

In step S708, the sink apparatus determines whether the sink apparatus receives an inquiry about the content redirection function during execution of mirroring. In a case where the inquiry is not received (NO in step S708), the processing returns to step S706. In step S706, the sink apparatus continues the mirroring processing. On the other hand, in a case where the inquiry is received (YES in step S708), the processing proceeds to step S709. In step S709, the sink apparatus determines whether the sink apparatus has connected to the access point 103. In a case where the sink apparatus has not connected to the access point 103 (NO in step S709), the processing proceeds to step S710. In step S710, the sink apparatus establishes a communication with the access point 103. When the communication with the access point 103 is established, the processing proceeds to step S711. On the other hand, in a case where the sink apparatus has connected to the access point 103 (YES in step S709), the processing proceeds to step S711. Example cases where the sink apparatus has connected to the access point 103 include a case where the sink apparatus connects to the access point 103 in step S710 and a case where the sink apparatus connects to the access point 103 before or during execution of mirroring.

In step S711, the sink apparatus determines whether content redirection is executable. In this case, the sink apparatus determines whether content redirection is executable based on the operation channels for the networks 110 and 111. More specifically, the sink apparatus acquires information about the operation channel for the network 111 in which a communication with the source apparatus has been established. Further, the sink apparatus information about the operation channel for the communication with the access point 103 established in step S710 or already established, and compares the operation channel with that of the network 111.

When the two operation channels are different from each other, the sink apparatus waits for data while switching the operation channel of the self apparatus (sink apparatus) on a time division basis. In this case, the sink apparatus may fail to receive data. For example, when the sink apparatus has received a video content from the access point 103, failure to receive data disturbs image and audio of the video content. Therefore, a case where the two operation channels are different from each other not suitable for the execution of content redirection, and the sink apparatus determines that content redirection is not executable.

In a case where the two operation channels are the same, the sink apparatus determines that content redirection is executable (YES in step S711). On the other hand, in a case where the two operation channels are different from each other, the sink apparatus determines that content redirection is not executable (NO in step S711).

According to the present embodiment, when the sink apparatus determines that an inquiry about the content redirection function is received in step S708, the sink apparatus determines whether content redirection is executable in step S711. However, when the communication with the access point 103 has been established before step S709, the processing is not limited thereto. After establishing a communication with the source apparatus in step S705, the sink apparatus can perform the determination at any time. In this case, upon reception of an inquiry about the content redirection function in step S708, then in step S711, the sink apparatus needs to select “YES” or “NO” based on the result of the determination already performed.

In a case where the sink apparatus determines that content redirection is not executable, then in step S712, the sink apparatus determines whether the role of the self apparatus is a GO. More specifically, the sink apparatus performs this determination based on whether the role of the sink apparatus is a GO or CL as a result of the GO Negotiation in step S703. In a case where the role of the sink apparatus is a GO (YES in step S712), the processing proceeds to step S713. On the other hand, in a case where the role of the sink apparatus is a CL (NO in step S712), the processing proceeds to step S714.

In a case where the role of the sink apparatus is a GO (YES in step S712), then in step S713, the sink apparatus changes the operation channel for the communication with the source apparatus. More specifically, the sink apparatus changes the operation channel for the communication with the source apparatus to the same operation channel as the one for the communication with the access point 103. On the other hand, in a case where the role of the sink apparatus is a CL (NO in step S712), then in step S714, the sink apparatus transmits a request for changing the operation channel to the source apparatus. This signal requests the source apparatus to change the operation channel for the network 111. More specifically, the request for changing the operation channel sets the operation channel for the communication with the source apparatus so as to be the same as the operation channel for the communication with the access point 103.

When the sink apparatus completes the processing in step S713 or S714, the processing proceeds to step S715. In step S715, the sink apparatus transmits an OK notification to the source apparatus. Steps S715 and S716 perform similar processing to steps S317 and S318 illustrated in FIG. 3, respectively. Steps S717 to S719 perform similar processing steps S323 to S325 illustrated in FIG. 3, respectively.

The sink apparatus that has reproduced the content in step S719 resumes mirroring in step S706. Alternatively, the processing can return to step S701, and the sink apparatus can wait until mirroring is started. The processing can return to step S716, and the sink apparatus can receive information of a new content from the source apparatus. Yet alternatively, while the sink apparatus is acquiring and reproducing a content in step S719, the sink apparatus can receive information of a new content from the source apparatus and then reproduce the content. Then, the processing can return to step S718, and the sink apparatus can request the cloud server 104 for a new content.

The flowchart illustrated in FIG. 7 indicates processing performed by the sink apparatus to implement content redirection.

In this flowchart, the sink apparatus determines whether a communication with the access point 103 has been established in step S709, and determines whether the operation channels for the two communications are different from each other in step S711. In a case where a communication with the access point 103 has not been established in step S709, the sink apparatus establishes a communication with the access point 103 in step S710. However, the sink apparatus can establish a communication with the access point 103 after any one of steps S711 to S716. In this case, the sink apparatus can perform the determination in step S711 by searching for connectable access points around the sink apparatus to detect a connectable access point, and acquiring information of the operation of the access point. When a plurality of connectable access points is detected, and in a case where there is an access point connectable through the same operation channel as the one for the communication with the source apparatus, the sink apparatus determines that content redirection is executable (YES in step S711). In this case, in a step for establishing a connection with an access point, the sink apparatus preferentially establishes a connection with the access point connectable through the same operation channel.

The processing procedure of the flowchart for the communication apparatus 102 illustrated in FIG. 7 is implemented when the control unit 202 reads a program stored in the storage unit 201 of the communication apparatus 102. At least a part or whole of the sequence diagram illustrated in FIG. 7 can be implemented by hardware. When the sequence diagram is implemented by hardware, a dedicated circuit is generated on an FPGA based on a program for implementing each step by using a predetermined compiler, and then use the circuit. Similar to the FPGA, the sequence diagram can be implemented by hardware, i.e., also by forming a Gate Array circuit. The sequence diagram can be implemented also by using an ASIC.

Each step of the flowchart illustrated in FIG. 7 can be implemented by a plurality of CPUs or apparatuses (not illustrated) in a distributed way. When implementing each step by a plurality or apparatuses in a distributed way, the source and sink apparatuses operate as a source and a sink system, respectively.

According to a second embodiment, in a case where content redirection is determined to be not executable based on the operation channels for the two communications, the operation channel for the communication with the source apparatus is changed to make content redirection executable. More specifically, when performing content redirection, the sink apparatus needs to concurrently perform both the communication with the access point 103 and the communication with the source apparatus. If the operation channel for the communication with the source apparatus is different from the operation channel for the communication with the access point 103, the sink apparatus operates while switching the operation channel of the self apparatus (sink apparatus) on a time division basis. However, the sink apparatus may fail to receive data if the sink apparatus waits for data while switching the operation channel on a time division basis. Such a case is not suitable for the execution of content redirection. Then, when the operation channels for the two communication are different from each other, the operation channel for the communication with the source apparatus is changed to the same operation channel as the one for the communication with the access point 103, thus a state between the apparatuses becomes suitable for the execution of content redirection.

According to the first and the second embodiments, an inquiry about the content redirection function transmitted from the source apparatus to the sink apparatus includes a request for information about an application capable of performing content redirection out of applications of the sink apparatus. The information about an application includes the name, type, and issuer of the application. Alternatively, the information can include an inquiry about whether the sink apparatus is able to perform content redirection. Alternatively, the information can include at least one of an instruction for starting content redirection and information of a content.

According to the first and the second embodiments, when the sink apparatus acquires a content from an external apparatus and is reproducing the content, the source and sink apparatuses can transmit information about the reproduction of the content through the communication between the source and sink apparatuses. More specifically, the source apparatus can transmit reproduction control information for controlling the content to the sink apparatus. More specifically, the source apparatus transmits reproduction control information, such as the stop and fast forward states of the content, to the sink apparatus to control the content currently reproduced by the sink apparatus. The reproduction control information to be transmitted can include the pause, rewinding, reproduction, and volume change states. The reproduction control information can also include an instruction for moving the content reproduction position up to a user-specified time in the content. Alternatively, the source apparatus can transmit to the sink apparatus information about a content which the user wants to reproduce following the content currently reproduced by the sink apparatus.

In addition, the sink apparatus can transmit reproduction status information of the content to the source apparatus through the communication between the source and sink apparatuses. The reproduction status information of a content refers to information indicating, for example, that the content has been in the stop or fast forward state. More specifically, when a user operation indicating a stop of the reproduction of the content is input via the source or sink apparatus, the reproduction of the content is stopped. The sink apparatus transmits the state where the reproduction of the content has been stopped to the source apparatus. The reproduction status information of the content can include the stop, rewinding, and reproduction states. If an error related to the reproduction of the content occurs on the sink apparatus, the sink apparatus can transmit information about the error to the source apparatus. The sink apparatus can transmit, for example, information indicating the error, information about the cause of the error, and information about the type of the error to the source apparatus. Alternatively, the sink apparatus can transmit information about the user operation input from the sink apparatus to the source apparatus. When the reproduction of the content is completed on the sink apparatus, the sink apparatus can notify the source apparatus of the completion of the reproduction of the content. After the reproduction of the content on the sink apparatus completed, the sink apparatus can transmit information indicating that no data is currently reproduced.

According to the first and the second embodiments, the sink apparatus receives an inquiry about the content redirection function after mirroring is started. However, the processing is not limited thereto. Instead of an instruction for starting mirroring in step S301 illustrated in FIG. 3 or step S701 illustrated in FIG. 7, the sink apparatus can also receive an inquiry about the content redirection function. In this case, according to the first embodiment, the sink apparatus receives an inquiry about the content redirection function in step S301 illustrated in FIG. 3, and then performs processing in steps S302 to S305. Then, the sink apparatus can skip steps S306 to S308, and the processing may proceed to step S309. According to the second embodiment, the sink apparatus receives an inquiry about the content redirection function in step S701 illustrated in FIG. 7, and then performs processing in steps S702 to S705. Then, the sink apparatus can skip steps S706 to S708, and the processing may proceed to step S709.

According to the first and the second embodiments, when changing the operation channel for the communication between the sink and source apparatuses, the communication between the sink and source apparatuses is not disconnected. However, according to the first and the second embodiments, when changing the operation channel for the communication between the sink and source apparatuses, the communication between the sink and source apparatuses can be disconnected before changing the operation channel and then reconnected after changing the operation channel.

For example, according to the first embodiment, in a case where the operation channels for the two communication are determined to be different from each other in step S321 illustrated in FIG. 3, the sink apparatus transmits an NG notification to the source apparatus. Then, the sink apparatus disconnects the communication with the source apparatus. More specifically, the sink apparatus issues a RTSP TEARDOWN message conforming to Wi-Fi® Display specifications and then transmits the message. As a result, the communication between the sink and source apparatuses is disconnected. More specifically, the Wi-Fi® Display session is disconnected. In this case, the TCP connection and Wi-Fi® P2P connection between the sink and source apparatuses can be disconnected. Alternatively, when a TDLS connection conforming to TDLS has been performed as a Wi-Fi® Display connection, the TDLS connection is disconnected instead of the Wi-Fi® P2P connection. Upon reception of the RTSP SET_PARAMETER message from the source apparatus, the sink apparatus can issue a RTSP TEARDOWN message and then transmit the message. Further, the sink apparatus can omit an NG notification and then transmit a RTSP TEARDOWN message. The sink apparatus that has disconnected the communication with the source apparatus changes the operation channel for the communication with the source apparatus. The sink apparatus that has changed the operation channel performs the connection setup and Capability Negotiation and then establishes a session. The sink apparatus that has completed up to the session establishment proceeds to the mirroring processing in step S306 and then follows the subsequent steps of the flowchart illustrated in FIG. 3.

For example, according to the second embodiment, in a case where the operation channels for the two communication are determined to be different from each other in step S711 illustrated in FIG. 7, the sink apparatus transmits an NG notification to the source apparatus. Then, the sink apparatus determines whether the role of the self apparatus (sink apparatus) is a GO. In a case where the role of the self apparatus (sink apparatus) is a GO, the sink apparatus disconnects the communication with the source apparatus. More specifically, the sink apparatus issues a RTSP TEARDOWN message conforming to Wi-Fi® Display specifications and then transmits the message. As a result, the communication between the sink and source apparatuses is disconnected. More specifically, the Wi-Fi® Display session is disconnected. In this case, the TOP connection and Wi-Fi® P2P connection between the sink and source apparatuses can be disconnected. Alternatively, when a TDLS connection conforming to TDLS has been performed as a Wi-Fi® Display connection, the TDLS connection is disconnected instead of the Wi-Fi® P2P connection. Upon reception of a RTSP SET_PARAMETER message from the source apparatus, the sink apparatus can issue and transmit a RTSP TEARDOWN message. Further, the sink apparatus can omit an NG notification and then transmit a RTSP TEARDOWN message. The sink apparatus that has disconnected the communication with the source apparatus changes the operation channel for the communication with the source apparatus so that content redirection is determined to be executable. On the other hand, in a case where the role of the sink apparatus is a CL, the sink apparatus transmits a request for changing the operation channel to the source apparatus. Then, the sink apparatus disconnects the communication with the source apparatus. Subsequently, also in a case where the role of the sink apparatus is a GO or CL, the sink apparatus performs the connection setup and Capability Negotiation and then establishes a session. The sink apparatus that has completed up to the session establishment proceeds to the mirroring processing in step S706 and then follows the subsequent steps of the flowchart illustrated in FIG. 7.

According to the first embodiment, the sink apparatus determines whether content redirection is executable based on the role of the sink apparatus. According to the second embodiment, the sink apparatus determines whether content redirection is executable based on the operation channel for the network 111 and the operation channels for the communications with the sink apparatus and the access point. Then, when content redirection is determined to be not executable in these determinations, the sink apparatus changes the role and operation channel for the network 111.

However, even if content redirection is determined to be not executable, the sink apparatus can perform content redirection by temporarily disconnecting the Wi-Fi® P2P connection between the source and sink apparatuses. More specifically, if the communication between the source and sink apparatuses is disconnected, the concurrent connections of the networks 110 and 111 are not performed. Therefore, regardless of the role or operation channel, the sink apparatus is able to connect to an external apparatus to acquire a content.

In each embodiment, the cloud server 104 needs to hold at least one content. The communication apparatuses 101 and 102 need to reproduce at least one content through content redirection. Further, the communication apparatus 102 can receive information about a plurality of contents from the communication apparatus 101 in step S318 illustrated in FIG. 3 or in step S716 illustrated in FIG. 7. In this case, based on the received information about a plurality of contents, the communication apparatus 102 acquires at least one content from the cloud server 104 and then reproduces the contents.

Although the present disclosure has been described above based on the embodiments, the present disclosure can be embodied, for example, as a system, an apparatus, a method, a program, or a recording medium (storage medium). More specifically, the present disclosure is applicable to a system composed of a plurality of apparatuses (for example, a host computer, an interface device, an imaging apparatus, a web application, etc.) and to an apparatus composed of one device.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to suitably acquire a content from an external apparatus even if a connection state between a self apparatus and another communication apparatus is not suitable for the content acquisition from the external apparatus.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2017-089722, filed Apr. 28, 2017, which is hereby incorporated by reference herein in its entirety.

1. A communication apparatus comprising:
a first connection unit configured to connect with an other communication apparatus via a first wireless network;
a first reception unit configured to receive a predetermined signal from the other communication apparatus via the first wireless network, wherein the predetermined signal is transmitted by the other communication apparatus in a case where the communication apparatus is instructed to acquire a content included in an external apparatus, and wherein the other communication apparatus is connected by the first connection unit;
a changing unit configured to change, in a case where the communication apparatus is assigned a role of participating in the first wireless network when the first reception unit receives the predetermined signal, the connection with the other communication apparatus to a connection via a second wireless network in which the communication apparatus is assigned a role of establishing a wireless network;
an acquisition unit configured to acquire, in a case where the changing unit has changed the connection with the other communication apparatus, the content from the external apparatus via a third wireless network while maintaining the connection via the second wireless network; and
a communication unit configured to communicate, in a case where the content is acquired by the acquisition unit, information about reproduction of the content with the other communication apparatus via the second wireless network.

2. The communication apparatus according to claim 1, further comprising a determination unit configured to determine whether the communication apparatus is to be assigned a role of establishing a wireless network, based on a first value included in the communication apparatus and a second value included in the other communication apparatus,
wherein the changing unit changes the connection with the other communication apparatus from the connection via the first wireless network to the connection via the second wireless network, by changing the first value such that the second wireless network where the communication apparatus is assigned a role of establishing a wireless network is able to be established.

3. The communication apparatus according to claim 1, further comprising a second reception unit configured to receive, in a case where the changing unit has changed the connection with the other communication apparatus to the connection via the second wireless network, information of the content included in the external apparatus from the other communication apparatus via the second wireless network,
wherein the acquisition unit acquires the content based on the information of the content received by the second reception unit.

4. The communication apparatus according to claim 1, further comprising an establishing unit configured to establish, in a case where connecting with the external apparatus is established via the third wireless network using a first operation channel, the second wireless network by using the first operation channel.

5. The communication apparatus according to claim 1, further comprising a notification unit configured to notify, based on a fact that the communication apparatus is connected with the other communication apparatus by the first connection unit in a case where the first reception unit receives the predetermined signal, the other communication apparatus that the acquisition unit is unable to acquire the content from the external apparatus.

6. The communication apparatus according to claim 1,
wherein, in a case where the communication apparatus is assigned a role of establishing the first wireless network, the changing unit does not change the connection with the other communication apparatus to the connection via the second wireless network,
wherein the acquisition unit acquires the content from the external apparatus via the third wireless network while maintaining the connection via the first wireless network, and
wherein, in a case where acquiring the content is performed by the acquisition unit, the communication unit communicates the information about the reproduction of the content with the other communication apparatus via the first wireless network.

7. The communication apparatus according to claim 6, further comprising a determination unit configured to determine whether the communication apparatus is assigned a role of establishing the first wireless network or a role of participating therein,
wherein, in a case where the determination unit determines that the communication apparatus is assigned a role of participating in the first wireless network, the changing unit changes the connection with the other communication apparatus from the connection via the first wireless network to the connection via the second wireless network, and
wherein, in a case where the determination unit determines that the communication apparatus is assigned a role of establishing the first wireless network, the changing unit does not change the connection with the other communication apparatus from the connection via the first wireless network.

8. The communication apparatus according to claim 1, further comprising a third connection unit configured to connect to an access point via the third wireless network established by the access point,
wherein the communication apparatus connects with the external apparatus via the access point.

9. The communication apparatus according to claim 1, wherein each of the first and the second wireless networks is a wireless network conforming to a Wi-Fi® Direct standard.

10. The communication apparatus according to claim 1, wherein the predetermined signal includes an inquiry about an application capable of acquiring the content from the external apparatus.

11. The communication apparatus according to claim 1, wherein the predetermined signal includes an inquiry about whether acquisition and reproduction of the content included in the external apparatus are executable.

12. The communication apparatus according to claim 1, further comprising a control unit configured to control, based on the information about reproduction of the content received from the other communication apparatus by the communication unit, at least one of acquisition of the content by the acquisition unit and reproduction of the content.

13. The communication apparatus according to claim 1, further comprising a fourth reception unit configured to receive from the other communication apparatus at least one of information of a screen currently displayed and information of an audio currently reproduced by the other communication apparatus,
wherein, in a case where the fourth reception unit has received at least one of the information of the screen and the information of the audio, the first reception unit receives the predetermined signal.

14. The communication apparatus according to claim 13, wherein the fourth reception unit receives at least one of the information of the screen and the information of the audio through communication conforming to a Wi-Fi® Miracast® standard.

15. The communication apparatus according to claim 1, wherein the communication unit transmits, as the information about reproduction of the content, information indicating that the content is in at least one of a reproduction, stop, fast forward, rewinding, pause, and error state to the other communication apparatus.

16. The communication apparatus according to claim 1, wherein the communication unit receives, as the information about reproduction of the content, information indicating at least one of instructions of a reproduction, stop, fast forward, rewinding, pause, volume change, and reproduction position specification from the other communication apparatus.

17. The communication apparatus according to claim 16, wherein at least one of the first, the second, and the third wireless networks is a wireless network conforming to an IEEE 802.11 series standard.

18. A communication apparatus comprising:
a first connection unit configured to connect with an other communication apparatus by using a first operation channel;
a second connection unit configured to connect with an external apparatus by using a second operation channel;
a first reception unit configured to receive a predetermined signal from the other communication apparatus connected by the first connection unit, wherein the predetermined signal is transmitted by the other communication apparatus in a case where the communication apparatus is instructed to acquire a content included in the external apparatus;
a changing unit configured to change, in a case where the first and the second operation channels are different from each other when the first reception unit receives the predetermined signal, the connection with the other communication apparatus from a connection using the first operation channel to a connection using the second operation channel;
an acquisition unit configured to acquire, in a case where the changing unit has changed the connection with the other communication apparatus, the content from the external apparatus connected by the second connection unit while maintaining the connection with the other communication apparatus using the second operation channel; and
a communication unit configured to communicate, in a case where the content is acquired by the acquisition unit, information about reproduction of the content with the other communication apparatus connected by using the second operation channel.

19. The communication apparatus according to claim 18, wherein, in a case where the communication apparatus is assigned a role of participating in a wireless network with the other communication apparatus when connecting with the other communication apparatus by the first connection unit, the changing unit changes, by requesting the other communication apparatus to change the operation channel, the connection with the other communication apparatus from the connection using the first operation channel to the connection using the second operation channel.

20. The communication apparatus according to claim 18, further comprising a notification unit configured to notify the other communication apparatus that the acquisition unit is unable to acquire the content from the external apparatus, based on a fact that the first operation channel is different from the second operation channel in a case where the first reception unit receives the predetermined signal.

21. The communication apparatus according to claim 18, further comprising a second reception unit configured to receive the information of the content included in the external apparatus from the other communication apparatus in a case where the changing unit has changed the connection with the other communication apparatus,
wherein the acquisition unit acquires the content based on the information of the content received via the second reception unit.

22. The communication apparatus according to claim 18, further comprising:
a third connection unit configured to allow the communication apparatus to connect with the other communication apparatus by using the second operation channel; and
a third reception unit configured to receive a predetermined signal from the other communication apparatus connected by the third connection unit, wherein the predetermined signal is transmitted by the other communication apparatus in a case where the communication apparatus is instructed to acquire a content included in the external apparatus,
wherein, in a case where the third reception unit receives the predetermined signal, the changing unit does not change the connection with the other communication apparatus, and
wherein, in a case where the changing unit does not change the connection with the other communication apparatus, the acquisition unit acquires the content from the external apparatus while maintaining the connection with the other communication apparatus using the second operation channel.

23. The communication apparatus according to claim 22, further comprising a determination unit configured to determine whether the communication apparatus has connected with the other communication apparatus by either the first or the third connection unit,
wherein, in a case where the determination unit determines that the communication apparatus has connected with the other communication apparatus by the first connection unit, the changing unit changes the connection with the other communication apparatus from the connection using the first operation channel to the connection using the second operation channel, and
wherein, in a case where the determination unit determines that the communication apparatus has connected with the other communication apparatus by the third connection unit, the changing unit does not change the connection with the other communication apparatus.

24. The communication apparatus according to claim 18, further comprising a fourth connection unit configured to connect to an access point,
wherein the communication apparatus connects with the external apparatus via the access point.

25. The communication apparatus according to claim 18, wherein each of the connection with the other communication apparatus using the first operation channel and the connection with the other communication apparatus using the second operation channel is a connection conforming to the Wi-Fi® Direct standard.

26. The communication apparatus according to claim 18, wherein the predetermined signal includes an inquiry about an application capable of acquiring the content from the external apparatus.

27. The communication apparatus according to claim 18, wherein the predetermined signal includes an inquiry about whether acquisition and reproduction of the content included in the external apparatus are executable.

28. The communication apparatus according to claim 18, further comprising a control unit configured to control, based on the information about reproduction of the content received from the other communication apparatus by the communication unit, at least one of acquisition of the content by the acquisition unit and reproduction of the content.

29. The communication apparatus according to claim 18, further comprising a fourth reception unit configured to receive from the other communication apparatus at least one of information of a screen currently displayed and information of an audio currently reproduced by the other communication apparatus,
wherein, in a case where the fourth reception unit receives at least one of the information of the screen and the information of the audio, the first reception unit receives the predetermined signal.

30. The communication apparatus according to claim 29, wherein the fourth reception unit receives at least one of the information of the screen and the information of the audio through communication conforming to the Wi-Fi® Miracast® standard.

31. The communication apparatus according to claim 18, wherein the communication unit transmits, as the information about reproduction of the content, information indicating that the content is in at least one of a reproduction, stop, fast forward, rewinding, pause, and error state to the other communication apparatus.

32. The communication apparatus according to claim 18, wherein the communication unit receives, as the information about reproduction of the content, information indicating at least one of instructions of a reproduction, stop, fast forward, rewinding, pause, volume change, and reproduction position specification from the other communication apparatus.

33. The communication apparatus according to claim 18, wherein at least one of the connection with the other communication apparatus using the first operation channel, the connection with the other communication apparatus using the second operation channel, and the connection with the external apparatus using the second operation channel is a connection conforming to the IEEE 802.11 series standard.

34. A communication apparatus comprising:
a connection unit configured to connect with an other communication apparatus via a first wireless network in a manner such that the communication apparatus is assigned a role of establishing a first wireless network and the other communication apparatus is assigned a role of participating in the first wireless network;
a first transmission unit configured to transmit, in a case where the other communication apparatus is instructed to acquire a content included in an external apparatus, a predetermined signal to the other communication apparatus via the first wireless network, wherein the other communication apparatus is connected via the connection unit;
a disconnection unit configured to disconnect, in a case where the first transmission unit has transmitted the predetermined signal, the connection with the other communication apparatus via the first wireless network;
a reconnection unit configured to reconnect, in a case where the disconnection unit disconnects the connection, with the other communication apparatus via the second wireless network where the other communication apparatus is assigned a role of establishing a wireless network;
a second transmission unit configured to transmit, in a case where the reconnection unit reconnects the connection, information of the content to the other communication apparatus via the second wireless network; and
a communication unit configured to communicate, in a case where the other communication apparatus acquires the content from the external apparatus based on the information of the content transmitted by the second transmission unit, information about reproduction of the content with the other communication apparatus via the second wireless network.

35. A communication apparatus comprising:
a connection unit configured to connect with an other communication apparatus via a first wireless network using a first operation channel;
a first transmission unit configured to transmit, in a case where the other communication apparatus is instructed to acquire a content included in an external apparatus, a predetermined signal to the other communication apparatus via the first wireless network, wherein the other communication apparatus is connected by the connection unit;
a changing unit configured to change, in a case where the first transmission unit has transmitted the predetermined signal, the connection with the other communication apparatus from the connection via the first wireless network to a connection via a third wireless network using the second operation channel, wherein the other communication apparatus is connected with the external apparatus via the second wireless network using the second operation channel;
a second transmission unit configured to transmit, in a case where the changing unit has changed the connection with the other communication apparatus, information of the content to the other communication apparatus via the second wireless network; and
a communication unit configured to communicate, in a case where the other communication apparatus acquires the content from the external apparatus based on the information of the content transmitted via the second transmission unit, information about reproduction of the content with the other communication apparatus via the third wireless network.

36. A method for controlling a communication apparatus, the method comprising:
connecting, as a first connection, with an other communication apparatus via a first wireless network;
receiving, as a first reception, a predetermined signal from the other communication apparatus via the first wireless network, wherein the predetermined signal is transmitted by the other communication apparatus in a case where the communication apparatus is instructed to acquire a content included in an external apparatus, and wherein the other communication apparatus is connected by the first connection;
changing, in a case where the communication apparatus is assigned a role of participating in the first wireless network when the first reception receives the predetermined signal, the connection with the other communication apparatus to a connection via a second wireless network in which the communication apparatus is assigned a role of establishing a wireless network;
acquiring, in a case where changing includes changing the connection with the other communication apparatus, the content from the external apparatus via a third wireless network while maintaining the connection via the second wireless network; and
communicating, in a case where the content is acquired, information about reproduction of the content with the other communication apparatus via the second wireless network.

37. A method for controlling a communication apparatus, the method comprising:
connecting, as a first connection, with an other communication apparatus by using a first operation channel;
connecting, as a second connection, with an external apparatus by using a second operation channel;
receiving, as a first reception, a predetermined signal from the other communication apparatus connected by the first connection, wherein the predetermined signal is transmitted by the other communication apparatus in a case where the communication apparatus is instructed to acquire a content included in the external apparatus;
changing, in a case where the first and the second operation channels are different from each other when the first reception receives the predetermined signal, the connection with the other communication apparatus from a connection using the first operation channel to a connection using the second operation channel;
acquiring, in a case where changing includes changing the connection with the other communication apparatus, the content from the external apparatus connected by the second connection while maintaining the connection with the other communication apparatus using the second operation channel; and
communicating, in a case where the content is acquired, information about reproduction of the content with the other communication apparatus connected by using the second operation channel.

38. A non-transitory computer-readable recording medium storing a program to cause a computer to perform a method for controlling a communication apparatus, the method comprising:
connecting, as a first connection, with an other communication apparatus via a first wireless network;
receiving, as a first reception, a predetermined signal from the other communication apparatus via the first wireless network, wherein the predetermined signal is transmitted by the other communication apparatus in a case where the communication apparatus is instructed to acquire a content included in an external apparatus, and wherein the other communication apparatus is connected by the first connection;
changing, in a case where the communication apparatus is assigned a role of participating in the first wireless network when the first reception receives the predetermined signal, the connection with the other communication apparatus to a connection via a second wireless network in which the communication apparatus is assigned a role of establishing a wireless network;
acquiring, in a case where changing includes changing the connection with the other communication apparatus, the content from the external apparatus via a third wireless network while maintaining the connection via the second wireless network; and
communicating, in a case where the content is acquired, information about reproduction of the content with the other communication apparatus via the second wireless network.

39. A non-transitory computer-readable recording medium storing a program to cause a computer to perform a method for controlling a communication apparatus, the method comprising:
connecting, as a first connection, with an other communication apparatus by using a first operation channel;
connecting, as a second connection, with an external apparatus by using a second operation channel;
receiving, as a first reception, a predetermined signal from the other communication apparatus connected by the first connection, wherein the predetermined signal is transmitted by the other communication apparatus in a case where the communication apparatus is instructed to acquire a content included in the external apparatus;
changing, in a case where the first and the second operation channels are different from each other when the first reception receives the predetermined signal, the connection with the other communication apparatus from a connection using the first operation channel to a connection using the second operation channel;
acquiring, in a case where changing includes changing the connection with the other communication apparatus, the content from the external apparatus connected by the second connection while maintaining the connection with the other communication apparatus using the second operation channel; and
communicating, in a case where the content is acquired, information about reproduction of the content with the other communication apparatus connected by using the second operation channel.
